(19) United States
(12) Patent Application Publication
(10) Pub. No.: US 2012/0053293 A1
(43) Pub. Date: Mar. 1, 2012

(54) SALT RESISTANT SEMI-AROMATIC COPOLYAMIDES

(75) Inventor: Anna Kutty Mathew, Kingston (CA)

(73) Assignee: E.I. DU PONT DE NEMOURS AND COMPANY, Wilmington (DE)

(21) Appl. No.: 13/219,926

(22) Filed: Aug. 29, 2011

Related U.S. Application Data
(60) Provisional application No. 61/379,036, filed on Sep. 1, 2010.

(51) Int. Cl. C08L 77/06; C08G 69/26

(52) U.S. Cl. 524/607; 528/339; 525/420

(57) ABSTRACT

Disclosed is a polyamide composition including a semi-aromatic copolyamide including about 70 to about 90 molar percent of repeat units of the formula (I)

—C(O)(CH₂)ₘC(O)NH(CH₂)₆NH— (I)

wherein m is 8, 10 and/or 12, and about 10 to about 30 molar percent of repeat units of the formula (II)

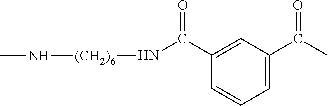

Also disclosed are vehicular parts, comprising the polyamide composition.

### CROSS REFERENCE TO RELATED APPLICATIONS

This application claims the benefit of priority to U.S. Provisional Application No. 61/379,036, filed Sep. 1, 2010.

### FIELD OF INVENTION

The present invention relates to the field of polyamide compositions having improved salt resistance.

### BACKGROUND OF INVENTION

Polymeric materials, including thermoplastics and thermosets, are used extensively in automotive vehicles and for other purposes. They are light and relatively easy to fashion into complex parts, and are therefore preferred instead of metals in many instances. However a problem with some polymers is salt stress (induced) corrosion cracking (SSCC), where a part under stress undergoes accelerated corrosion when under stress and in contact with inorganic salts. This often results in cracking and premature failure of the part.

Polyamides such as polyamide 6,6, polyamide 6, polyamide 6,10 and polyamide 6,12 have been made into and used as vehicular parts and other types of parts. While it has been reported that polyamides 6,10 and 6,12 are more resistant to SSCC (see for instance Japanese Patent 3271325B2), all of these polyamides are prone to SSCC in such uses, because for instance, various sections of vehicles and their components are sometimes exposed to salts, for example salts such as sodium chloride or calcium chloride used to melt snow and ice in colder climates. Corrosion of metallic parts such as fittings and frame components made from steel and various iron based alloys in contact with water and road salts can also lead to formation of salts. These salts, in turn, can attack the polyamide parts making them susceptible to SSCC. Thus polyamide compositions with better resistance to SSCC are desired.

U.S. Pat. No. 4,076,664 discloses a terpolyamide resin that has favorable resistance to zinc chloride.

US 2005/0234180 discloses a resin molded article having an excellent snow melting salt resistance, said article comprising 1 to 60% by weight of aromatic polyamide resin.

U.S. patent application Ser. No. 12/720,941, filed Mar. 10, 2010, herein incorporated by reference, discloses vehicular parts comprising a composition comprising a polyamide consisting essentially of PA 610/6T and/or PA 612/6T with a specific molar percent of repeat units.

### SUMMARY OF INVENTION

Disclosed is a polyamide composition comprising a semi-aromatic copolyamide consisting essentially of about 70 to about 90 molar percent of repeat units of the formula (I)

—C(O)(CH₂)ₘC(O)NH(CH₂)₆NH— (I)

wherein m is 8, 10 and/or 12, and about 10 to about 30 molar percent of repeat units of the formula (II)

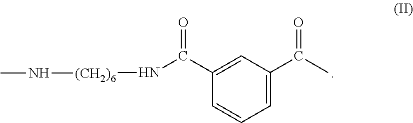

Also disclosed is a vehicular part, comprising the polyamide composition.

### DETAILED DESCRIPTION

One embodiment is a polyamide composition comprising a semi-aromatic copolyamide consisting essentially of about 70 to about 90 molar percent of repeat units of the formula (I)

—C(O)(CH₂)ₘC(O)NH(CH₂)₆NH— (I)

wherein m is 8, 10 and/or 12, and about 10 to about 30 molar percent of repeat units of the formula (II)

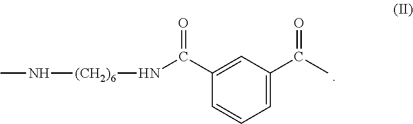

The term “m is 8, 10 and/or 12” means that m is one or more integers selected from the group consisting of 8, 10 and 12.

Herein the term “one semi-aromatic copolyamide consisting essentially of” means that the copolyamide may have present repeat units other than those specified in formula (I) and (II), but only to the extent that they do not affect the salt resistant properties and storage modulus properties of the composition, as measured with the salt resistance characterization and storage modulus characterization disclosed herein.

The semi-aromatic copolyamide may consist essentially of 70 to 90 mole percent repeat units of formula (I) and 10 to 30 mole percent repeat units of formula (II).

The semi-aromatic copolyamide may consist essentially of 80 to 90 mole percent repeat units of formula (I) and 10 to 20 mole percent repeat units of formula (II).

In various embodiments the semi-aromatic copolyamide has m is equal to 8, 10 and 12, respectively. In preferred embodiments the semi-aromatic copolyamide has m equal to 8 or 10.

The semi-aromatic copolyamide is formed from polycondensation of a mixture of aliphatic dicarboxylic acid and isophthalic acid with hexamethylene diamine (HMD) the molar ratio required to obtain the specified repeat units disclosed above. The aliphatic dicarboxylic acid monomers useful in preparing the copolyamides include decanedioic acid (C10), dodecanedioic acid (C12), and tetradecanedioic acid (C14).

The following list exemplifies the abbreviations used to identify monomers and repeat units in the semi-aromatic copolyamides (PA):
HMD hexamethylene diamine (or 6 when used in combination with a diacid)
DDA Decanedioic acid
DDDA Dodecanedioic acid
TDDA Tetradecanedioic acid
I Isophthalic acid
610 polymer repeat unit formed from HMD and DDA
612 polymer repeat unit formed from HMD and DDDA
614 polymer repeat unit formed from HMD and TDDA
6I polymer repeat unit formed from HMD and isophthalic acid

The copolyamide may be prepared by any means known to those skilled in the art, such as in a batch process using, for example, an autoclave or using a continuous process. See, for example, Kohan, M. I. Ed. Nylon Plastics Handbook, Hanser: Munich, 1995; pp. 13-32. Additives such as lubricants, antifoaming agents, and end-capping agents may be added to the polymerization mixture.

The copolyamide composition may optionally comprise additives including additives selected from the group consisting of polymeric tougheners, plasticizers, and reinforcing agents.

The polyamide composition, optionally, comprises 0 to 50 weight percent of a polymeric toughener comprising a reactive functional group and/or a metal salt of a carboxylic acid. In one embodiment the molded or extruded thermoplastic article comprises 2 to 20 weight percent polymeric toughener selected from the group consisting of: a copolymer of ethylene, glycidyl (meth)acrylate, and optionally one or more (meth)acrylate esters; an ethylene/α-olefin or ethylene/α-olefin/diene copolymer grafted with an unsaturated carboxylic anhydride; a copolymer of ethylene, 2-isocyanatoethyl (meth)acrylate, and optionally one or more (meth)acrylate esters; and a copolymer of ethylene and (meth)acrylic acid reacted with a Zn, Li, Mg or Mn compound to form the corresponding ionomer.

Herein the term “(meth)acrylic” and “(meth)acrylate” encompass acrylic acid and methacrylic acid, and esters of acrylic acid and methacrylic acid, respectively.

The copolyamide composition may optionally comprise at least one plasticizer. The plasticizer will preferably be miscible with the copolyamide. Examples of suitable plasticizers include sulfonamides, preferably aromatic sulfonamides such as benzenesulfonamides and toluenesulfonamides. Examples of suitable sulfonamides include N-alkyl benzenesulfonamides and toluenesulfonamides, such as N-butylbenzenesulfonamide, N-(2-hydroxypropyl)benzenesulfonamide, N-ethyl-o-toluenesulfonamide, N-ethyl-p-toluenesulfonamide, o-toluenesulfonamide, p-toluenesulfonamide, and the like. Preferred are N-butylbenzenesulfonamide, N-ethyl-o-toluenesulfonamide, and N-ethyl-p-toluenesulfonamide.

The plasticizer may be incorporated into the composition by melt-blending the polymer with plasticizer and, optionally, other ingredients, or during polymerization. If the plasticizer is incorporated during polymerization, the copolyamide monomers are blended with one or more plasticizers prior to starting the polymerization cycle and the blend is introduced to the polymerization reactor. Alternatively, the plasticizer can be added to the reactor during the polymerization cycle.

When used, the plasticizer will be present in the composition in about 1 to about 20 weight percent, or more preferably in about 6 to about 18 weight percent, or yet more preferably in about 8 to about 15 weight percent, wherein the weight percentages are based on the total weight of the composition.

The polyamide composition may optionally comprise 0 to about 60 weight percent, and preferably about 10 to 60 weight percent, and 15 to 50 weight percent, of one or more reinforcement agents. The reinforcement agent may be any filler, but is preferably selected from the group consisting calcium carbonate, glass fibers with circular and noncircular cross-section, glass flakes, glass beads, carbon fibers, talc, mica, wollastonite, calcined clay, kaolin, diatomite, magnesium sulfate, magnesium silicate, barium sulfate, titanium dioxide, sodium aluminum carbonate, barium ferrite, potassium titanate and mixtures thereof. Glass fibers, glass flakes, talc, and mica are preferred reinforcement agents.

The polyamide composition may optionally comprise additional additives such as thermal, oxidative, and/or light stabilizers; colorants; lubricants; mold release agents; and the like. Such additives can be added according to the desired properties of the resulting material, and the control of these amounts versus the desired properties is within the knowledge of the skilled artisan.

Herein the polyamide composition is a mixture by melt-blending, in which all polymeric ingredients are adequately mixed, and all non-polymeric ingredients are adequately dispersed in a polymer matrix. Any melt-blending method may be used for mixing polymeric ingredients and non-polymeric ingredients of the present invention. For example, polymeric ingredients and non-polymeric ingredients may be fed into a melt mixer, such as single screw extruder or twin screw extruder, agitator, single screw or twin screw kneader, or Banbury mixer, and the addition step may be addition of all ingredients at once or gradual addition in batches. When the polymeric ingredient and non-polymeric ingredient are gradually added in batches, a part of the polymeric ingredients and/or non-polymeric ingredients is first added, and then is melt-mixed with the remaining polymeric ingredients and non-polymeric ingredients that are subsequently added, until an adequately mixed composition is obtained. If a reinforcing filler presents a long physical shape (for example, a long glass fiber), drawing extrusion molding may be used to prepare a reinforced composition.

In another aspect, the present invention relates to a method for manufacturing an article by shaping the polyamide composition of the invention. Examples of articles are films or laminates, automotive parts or engine parts or electrical/electronics parts. By “shaping”, it is meant any shaping technique, such as for example extrusion, injection molding, thermoform molding, compression molding or blow molding. Preferably, the article is shaped by injection molding or blow molding.

Another embodiment includes the polyamide composition wherein the semi-aromatic copolyamide repeat units of formula (I) are present at about 80 to 90 molar percent and repeat units of formula (II) are present at 10 to 20 molar percent as disclosed above, wherein an injection molded test specimen, 50 mm×12 mm×3.2 mm, has a storage modulus retention of at least 10% at 125° C. (E′₁₂₅) as compared to the storage modulus at 23° C. (E′₂₃), as measured with dynamic mechanical analysis according to ISO6721-5, at a frequency of 1 Hz.

The molded or extruded thermoplastic articles disclosed herein may have application in many vehicular components that meet one or more of the following requirements: high impact requirements; significant weight reduction (over conventional metals, for instance); resistance to high temperature; resistance to oil environment; resistance to chemical agents such as coolants and road salts; and noise reduction allowing more compact and integrated design. Specific molded or extruded thermoplastic articles are selected from the group consisting of charge air coolers (CAC); cylinder head covers (CHC); oil pans; engine cooling systems, including thermostat and heater housings and coolant pumps; exhaust systems including mufflers and housings for catalytic converters; air intake manifolds (AIM); and timing chain belt front covers. Other molded or extruded thermoplastic articles disclosed herein are selected from the group consisting of pipes for transporting liquids and gases, inner linings for pipes, fuel lines, air break tubes, coolant pipes, air ducts, pneumatic tubes, hydraulic houses, cable covers, cable ties, connectors, canisters, and push-pull cables.

Another embodiment is a vehicular part, comprising a polyamide composition, comprising, a polyamide copolymer consisting essentially of about 70 to about 90 molar percent of repeat units of the formula

—C(O)(CH₂)ₘC(O)NH(CH₂)₆NH— (I)

wherein m is 8, 10 and/or 12, and about 10 to about 30 molar percent of repeat units of the formula (II)

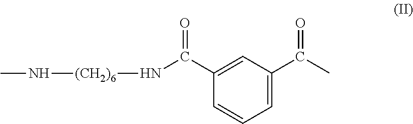

and provided that in normal operation said vehicular part is exposed to salt. Various specific embodiments of the vehicular part include all those disclosed above for the polyamide composition comprising a polyamide copolymer.

The present invention is further illustrated by the following examples. It should be understood that the following examples are for illustration purposes only, and are not used to limit the present invention thereto.

### Methods

Melting Points: In the Examples melting points are measured using ASTM Method ASTM D3418 at a heating rate of 10° C./min. On the first heat the melting point is taken as the peak of the melting endotherm.

Physical Properties Measurement

The Polyamide compositions were injection molded into test bars. The tensile and flexural properties were measured as per ASTM D638 and ASTM D790 test procedures, respectively. Tensile strength was measured using 115 mm (4.5 in) long and 3.2 mm (0.13 in) thick type IV tensile bars per ASTM D638-02a test procedure with a crosshead speed of 50 mm/min (2 in/min).

Storage Modulus Storage modulus was determined with DMA measurements on injection molded izod bars of the following dimensions: 50 mm×12 mm×3.2 mm. DMA measurements were made using a TA Instruments model DMA Q800 in single canti-lever mode with 20 micrometer amplitude, 1 Hz frequency and heating rate of 2° C./min from −140 to 150° C. Storage module at 23° C. (E′₂₃) and 125° C. (E′₁₂₅) was determined, and the ratio E′₁₂₅/E′₂₃×100% gave the retention of storage modulus.

SSCC Testing: ASTM D1693, Condition A, provides a test method for determination of environmental stress-cracking of ethylene plastics in presence of surface active agents such as soaps, oils, detergents etc. This procedure was adapted for determining stress cracking resistance of the copolyamides to SSCC as follows.

Rectangular test pieces measuring 37.5 mm×12 mm×3.2 mm were molded from the polyamide. A controlled nick was cut into the face of each molded bar as per the standard procedure, the bars were bent into U-shape with the nick facing outward, and positioned into brass specimen holders as per the standard procedure. At least five bars were used for each copolymer. The holders were positioned into large test tubes.

The test fluid used was 50% zinc chloride solution prepared by dissolving anhydrous zinc chloride into water in 50:50 weight ratio. The test tubes containing specimen holders were filled with freshly prepared salt solution fully immersing the test pieces such that there was at least 12 mm of fluid above the top test piece. The test tubes were positioned upright in a circulating air oven maintained at 50° C. Test pieces were periodically examined for development of cracks over a period of 24 hours, and in some cases up to 192 hours. In the Examples and Comparative Examples all tests are conducted at 50° C. unless otherwise noted.

### Materials

In all the Examples and Comparative Examples the copolyamide compositions contained 0.4% by weight of a stabilizer which was 7 parts by weight KI, 1 part CuI, and 1 part aluminum distearate.

PA610 refers to Zytel® ZYTFE310064 polyamide 610 made from 1,6-diaminohexane and 1,10-decanedioic acid available from E.I. DuPont de Nemours and Company, Wilmington, Del., USA.

PA612 is Zytel® 158 NC010 resin, having a melting point of about 218° C., available from E. I. du Pont de Nemours and Company, Wilmington, Del.

### Examples 1-3

The Synthesis of PA612/6I (85/15 mole ratio) illustrates the method for preparation of the PA 612/6I copolymers listed in Table 1.

Salt Preparation: A 10 L autoclave was charged with dodecanedioic acid (2266 g), isophthalic acid (288 g), an aqueous solution containing 78 weight % of hexamethylene diamine (HMD) (1760 g), an aqueous solution containing 28 weight percent acetic acid (37 g), an aqueous solution containing 1 weight percent sodium hypophosphite (35 g), an aqueous solution containing 1 weight percent Carbowax 8000 (10 g), and water (2185 g).

Process Conditions: The autoclave agitator was set to 5 rpm and the contents were purged with nitrogen at 10 psi for 10 minutes. The agitator was then set to 50 rpm, the pressure control valve was set to 1.72 MPa (250 psi), and the autoclave was heated. The pressure was allowed to rise to 1.72 MPa at which point steam was vented to maintain the pressure at 1.72 Mpa. The temperature of the contents was allowed to rise to 250° C. The pressure was then reduced to 0 psig over about 45 minutes. During this time, the temperature of the contents rose to 270° C. The autoclave pressure was reduced to 5 psia by applying vacuum and held there for 20 minutes. The autoclave was then pressurized with 65 psia nitrogen and the molten polymer was extruded into strands, quenched with cold water and cut into pellets.

The co-polyamide obtained had an inherent viscosity (IV) of 1.21 dl/g. The polymer had a melting point of 202° C., as measured by differential scanning calorimetry (DSC). For making other PA612/6I compositions, the quantitative amount of dodecanedioic acid and isophthalic acid were adjusted to achieve the desired mole ratio.

Examples 1-3, listed in Table 1, exhibit significantly improved SSCC in 50 weight percent ZnCl₂ as compared to PA610 and PA 612 homopolymers.

The results demonstrate that 10 to 30 mole percent of repeat units of formula (II) derived from isophthalic acid are surprising effective in improving the SSCC performance.

Furthermore, Example 1 comprising 15 mole percent of repeat units of formula (II) shows greater than 10% retention of storage modulus at 125° C. (E′₁₂₅), as compared to 23° C. (E′₂₃). The combination of properties, storage modulus retention and salt resistance as measured by SSCC, are important properties for many vehicular parts.

TABLE 1
Properties of 612/6I Copolyamides and Comparative Examples

| Example | 1 | 2 | 3 | C1 | C2 | C3 |
|---|---|---|---|---|---|---|
| Composition | PA612/6I | PA612/6I | PA612/6I | PA612/6I | PA612 | PA610 |
| (Mole %) | (85/15) | (75/25) | (70/30) | (60/40) | | |

DSC

| | | | | | | |
|---|---|---|---|---|---|---|
| Melting point (° C.) | 202 | 193 | 186 | 177 | 218 | 224 |

DMA

| | | | | | | |
|---|---|---|---|---|---|---|
| Storage modulus | 1941 | 1715 | 1631 | 1762 | 1988 | 1887 |
| @ 23° C., | | | | | | |
| E′₂₃ (MPa) | | | | | | |
| Storage modulus | 204 | 108 | 56 | 65 | 362 | 329 |
| @ 125° C., | | | | | | |
| E′₁₂₅ (MPa) | | | | | | |
| E′₁₂₅/E′₂₃ × 100% | 11 | 6 | 3 | 4 | 17 | 18 |

Physical Properties at 23° C. (DAM)

| | | | | | | |
|---|---|---|---|---|---|---|
| Tensile Strength | 69 | 56 | 70 | 68 | 67 | 63 |
| (MPa) | | | | | | |
| Elongation at Break | 35 | 19 | 225 | 161 | 37 | 194 |
| (%) | | | | | | |
| Tensile E-Modulus | 2089 | 1616 | 1645 | 1754 | 2153 | 1904 |
| (MPa) | | | | | | |

Salt Stress crack test in ZnCl₂ at 50° C. (Failures)

| | | | | | | |
|---|---|---|---|---|---|---|
| 0 hrs | 0/5 | 0/5 | 0/5 | 0/5 | 0/5 | 0/5 |
| 4 hrs | 0/5 | 0/5 | 0/5 | 0/5 | 5/5 | 5/5 |
| 24 hrs | 0/5 | 0/5 | 0/5 | 0/5 | 5/5 | 5/5 |
| 48 hrs | 5/5 | 0/5 | 0/5 | 0/5 | 5/5 | 5/5 |
| 72 hrs | 5/5 | 0/5 | 0/5 | 0/5 | 5/5 | 5/5 |
| 192 hrs | 5/5 | 0/5 | 0/5 | 0/5 | 5/5 | 5/5 |

We claim:

1. A polyamide composition comprising a semi-aromatic copolyamide consisting essentially of about 70 to about 90 molar percent of repeat units of the formula (I)
—C(O)(CH₂)ₘC(O)NH(CH₂)₆NH— (I)
wherein m is 8, 10 and/or 12, and about 10 to about 30 molar percent of repeat units of the formula (II)

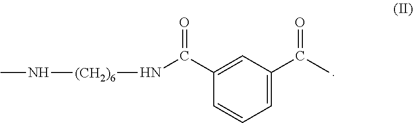

2. The polyamide composition of claim 1 wherein the semi-aromatic copolyamide repeat units of formula (I) are present at about 80 to 90 molar percent and repeat units of formula (II) are present at 10 to 20 molar percent.

3. The polyamide composition of claim 1 wherein said semi-aromatic copolyamide has m equal to 8.

4. The polyamide composition of claim 1 wherein said semi-aromatic copolyamide has m equal to 10.

5. The polyamide composition of claim 1 wherein said semi-aromatic copolyamide has m equal to 12.

6. The composition of claim 2 wherein an injection molded test specimen, 50 mm×12 mm×3.2 mm, has a storage modulus retention of at least 10% at 125° C. (E₁₂₅) as compared to the storage modulus at 23° C. (E′₂₃), as measured with dynamic mechanical analysis according to ISO6721-5, at a frequency of 1 Hz.

7. The polyamide composition of claim 1, further comprising one or more polymeric tougheners.

8. The polyamide composition of claim 1, further comprising one or more plasticizers.

9. A vehicular part, comprising a polyamide composition, comprising, a polyamide copolymer consisting essentially of about 70 to about 90 molar percent of repeat units of the formula
—C(O)(CH₂)ₘC(O)NH(CH₂)₆NH— (I)
wherein m is 8, 10 and/or 12, and about 10 to about 30 molar percent of repeat units of the formula (II) 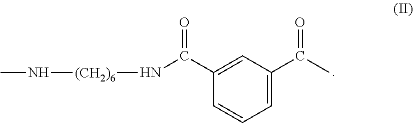
and provided that in normal operation said vehicular part is exposed to salt.

10. The vehicular part of claim 9 wherein the polyamide copolymer repeat units of formula (I) are present at about 80 to 90 molar percent and repeat units of formula (II) are present at 10 to 20 molar percent.

11. The polyamide composition of claim 9 wherein said semi-aromatic copolyamide has m equal to 8.

12. The polyamide composition of claim 9 wherein said semi-aromatic copolyamide has m equal to 10.

13. The polyamide composition of claim 9 wherein said semi-aromatic copolyamide has m equal to 12.

14. The polyamide composition of claim 9, further comprising one or more polymeric tougheners.

15. The polyamide composition of claim 9, further comprising one or more plasticizers.
